(19) United States
(12) Patent Application Publication
(10) Pub. No.: US 2012/0267589 A1
(43) Pub. Date: Oct. 25, 2012

(54) SKID STEER MOUNTED WIRE PULLER

(76) Inventor: BEN MELIN, Osceola, WI (US)

(21) Appl. No.: 13/091,242

(22) Filed: Apr. 21, 2011

(51) Int. Cl. H02G 1/08

(52) U.S. Cl. 254/134.3 R

(57) ABSTRACT

A skid steer mounted wirepuller comprising: a back plate; a rigid pipe extending from one side of the back plate; a pulley attached to one end of the pipe by using an attachment means; and a hydraulic motor to pull wire guided through the pulley. In one particular embodiment, the attachment means includes bolts. The back plate may include a top lip to attach the back plate to a shovel of the skid steer. Furthermore, a supply and a return may extend from the hydraulic motor to provide hydraulics for the motor.

### BACKGROUND OF THE INVENTION

1. Field of Invention

The present invention relates to a wirepuller that is capable to be mounted upon a skid steer for use at a construction site. p 2. Description of Related Art

Many construction sites for buildings or other facilities require the initial supply of electrical power to the construction site. This initial power is usually supplied through an electrical feed from a main power line. Occasionally this electrical feed must be transmitted through an underground conduit to reach the appropriate area for the construction. In order to place the wire at the construction site wire may have to be pulled through an underground conduit through various means. Some construction workers use a manual method to pull wire through conduit. Others have implemented the use of equipment to assist in wire pulling. One example of a portable wire pulling device is disclosed in U.S. Pat. No. 7,309,060 that discloses a portable wire pulling device that receives and utilizes rotational power from a cordless battery operated handrail that drives the rotation reel of the portable wire pulling device. Another example of a wire puller is disclosed in U.S. Pat. No. 5,653,293 that discloses a portable wire puller designed to be operated from a motor vehicle having a hydraulic system. The wire puller utilizes a spool mounted on an axle which is made of two rods that can be easily connected or disconnected from each other. The wire puller of the '293 patent utilizes a hydraulic system of a motor vehicle to power the wire puller.

### SUMMARY OF THE INVENTION

The present invention relates to a skid steer mounted wirepuller comprising: a back plate; a rigid pipe extending from one side of the back plate; a pulley attached to one end of the pipe by using an attachment means; and a hydraulic motor to pull wire guided through the pulley. In one particular embodiment, the attachment means includes bolts. The back plate may include a top lip to attach the back plate to a shovel of the skid steer. Furthermore, a supply and a return may extend from the hydraulic motor to provide hydraulics for the motor.

### BRIEF DESCRIPTION OF DRAWINGS

FIG. 1 depicts a side view of the skid steer wirepuller according to the present invention.

FIG. 2 depicts the front view of the skid steer wirepuller according to the present invention.

### DETAILED DESCRIPTION

The present invention relates to a skid steer mounted wirepuller that is utilized in construction sites in conjunction with a skid steer. The skid steer vehicle is commonly used at the construction sites principally due to its mobility and its ability to pivot steer with limited movement over the surface area. The present invention provides a means to place a wirepuller onto a skid steer so that the wirepuller is available that it directly mounted on the skid steer. By being mounted on the skid steer, the wirepuller may be used in tight situations as needed and maneuvered appropriately to perform the wire pulling function.

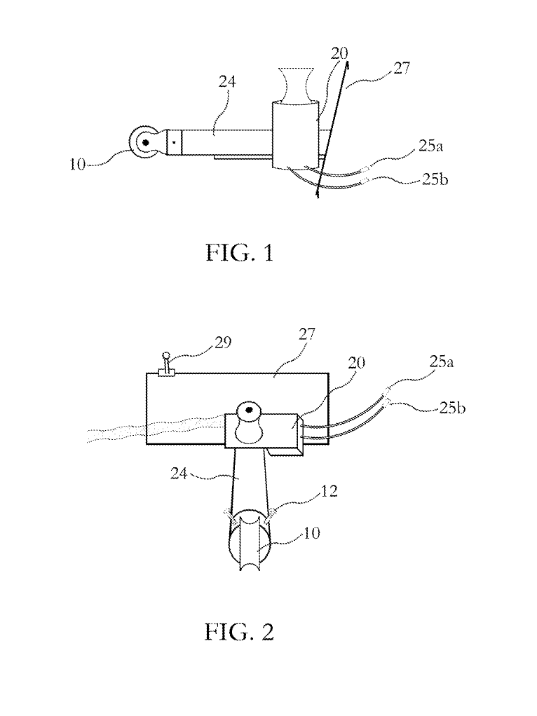

In reference to FIG. 1, a skid steer mounted wirepuller according to the present invention is depicted. The skid steer wirepuller according to the present invention includes a hydraulic Motor 20 that is used to turn and maneuver the wire through a Pulley 10. The Pulley 10 is attached to a Rigid Pipe 24 that extends from a Back Plate 27. The Back Plate 27 attaches to an attachment mount plate that is typically available on the common skid steer and therefore provides a means to mount the wirepuller onto the skid steer vehicle. As is shown, the Back Plate 27 includes a top lip that is firmly inserted onto the skid steer mounting plate. Supply Line 25a and Return Line 25b extend from the Hydraulic Motor 20. The Supply Line 25a and Return Line 25b connect to a hydraulic system in order to provide hydraulics for the Motor 20.

In reference to FIG. 2, a front view of the skid steer mounted wirepuller according to the present invention as depicted. As shown, the Pulley 10 is attached to the Rigid Pipe 24. The Pulley 10 is mounted upon the Pipe 24 through the use of Bolts 12 that are shown in FIG. 2. Also depicted in FIG. 2 is an on and off Lever 29, where the Lever 29 is used to turn the Pulley 10 between on and off position. Also a top view of the Hydraulic Motor 20 is shown which effectively activates the pulley system of the wirepuller according to the present invention.

The wirepuller according to the present invention is conveniently mounted upon the skid steer and therefore provides an effective means to effectively maneuver in tight positions that are typically experienced on a construction site. The Rigid Pipe 24 that extends from the wirepuller may measure up to 4 feet in length and allow for the boom to be extended below ground level to effectively pull wire through a conduit. The instant invention has been shown and described in what it considers to be the most practical and preferred embodiments. It is recognized, however, that departures may be made there from within the scope of the invention and that obvious modifications will occur to a person skilled in the art.

What is claimed is:

1. A skid steer mounted wirepuller comprising:
a. a back plate;
b. a rigid pipe extending from one side of the back plate;
c. a pulley attached to one end of the pipe by using an attachment means; and
d. a hydraulic motor to pull wire guided through the pulley.

2. The skid steer according to claim 1, where the attachment means includes bolts.

3. The skid steer according to claim 1 where the back plate include a top lip to attach the back plate to a shovel of the skid steer.

4. The skid steer according to claim 1, further including a supply and a return extending from the hydraulic motor to provide hydraulics for the motor.
